(19) United States
(12) Patent Application Publication
(10) Pub. No.: US 2021/0402649 A1
(43) Pub. Date: Dec. 30, 2021

(54) APPARATUS AND METHOD FOR HEATING PLASTIC PREFORMS WITH ADJUSTABLE FOCUSING DEVICE

(71) Applicant: KRONES AG, Neutraubling (DE)

(72) Inventors: Michael Eifler, Bernhardswald (DE); Wolfgang Schoenberger, Brennberg (DE); Simon Moewes, Regensburg (DE)

(21) Appl. No.: 17/347,812

(22) Filed: Jun. 15, 2021

(30) Foreign Application Priority Data
Jun. 24, 2020 (DE) 10 2020 116 681.8

(51) Int. Cl. B29B 13/08; B29C 31/00

(52) U.S. Cl. CPC B29B 13/08; B29C 31/008

(57) ABSTRACT

Provided is an apparatus for heating plastic preforms with a transport device which is suitable and intended for transporting the plastic preforms along a predetermined transport path, with at least one stationary arrange heating device which heats the plastic preforms transported along the transport path, wherein the heating device has at least one heating element which emits radiation which heats the plastic preforms and at least one focusing device which focuses the radiation emitted by the heating element onto predetermined regions of the plastic preforms to be heated, wherein a position of this focusing device is changeable.

### CROSS-REFERENCE TO RELATED APPLICATION

This application claims priority to German Application No. 10 2020 116 681.8, having a filing date of Jun. 24, 2020, the entire contents of which are hereby incorporated by reference.

### FIELD OF TECHNOLOGY

The following relates to an apparatus and a method for heating plastic preforms. In the field of the beverage manufacturing industry, it has long been known that plastic preforms are heated and subsequently formed into plastic containers, such as plastic bottles, in forming devices such as stretch blow moulding machines. During this heating process, it is also known that certain areas of the plastic preforms should not be heated, such as the mouth areas, which have a thread for screwing on a closure. To protect these areas, shielding elements and shielding plates are some-times provided.

### BACKGROUND

However, this has the disadvantage that the areas below the areas that do not need to be heated, for example the areas below a support ring, are not heated sufficiently in some cases and thus, as a result, not enough material can be stretched from these areas.

Therefore, focusing devices are known from the conventional art which focus the heating radiation into these areas of the plastic preforms. For example, it is known that a plastic preform is heated under its support ring by a focusing device, such as a parabolic or elliptical focusing device.

These focusing devices are also adjusted by the user or the machine operator, in particular to the area of the plastic preform to be heated. When changing over to other plastic preforms, the setting of this focusing device must therefore also be changed manually in the conventional art.

One problem with this changeover is sometimes a lack of repeat accuracy due to manual adjustment after a changeover. For this reason, the heating process can also vary for a specific plastic preform or a specific type of plastic preform to be heated. This can lead to variations in the quality of the customer's project. In addition, the manual adjustment of this focussing device leads to increased downtime.

### SUMMARY

An aspect relates to a conversion of these heating devices, in particular also to different plastic preforms to be heated.

An apparatus according to embodiments of the invention for heating plastic preforms has a transport device which is suitable and intended for transporting the plastic preforms along a predetermined transport path. In addition, at least one stationary arranged heating device is provided, which heats the plastic preforms transported along the transport path. The heating device has at least one heating element which emits radiation which heats the plastic preforms, and also a focusing device which focuses and/or directs the radiation emitted by a heating element onto predetermined areas of the plastic preforms to be heated.

According to embodiments of the invention, a position of this focusing device is changeable. In particular, a position of this focusing device in relation to the transport path of the containers and/or a position of the plastic preforms can be changed.

This changeability is desirable in order to achieve adaptation to different plastic preforms.

In an embodiment, the heating element is an infrared radiator. This means that the radiation mentioned here is in particular infrared radiation, which is used to heat the plastic preforms. During operation, the plastic preforms are guided past this heating element.

In a further embodiment, the at least one heating element extends along the transport path.

In a further advantageous embodiment, several heating elements are provided, which are arranged one above the other in a longitudinal direction of the plastic preforms to be heated. All of these heating elements can also extend along the transport path of the plastic preforms.

It is possible that some of these heating elements are equipped with a focusing device and some without a corresponding focusing device.

As mentioned above, not all areas of the transported plastic preforms should be heated. In particular, a mouth area of the plastic preforms should not be heated. For this purpose, shielding devices can be provided which shield the heating radiation of the heating elements from the mouths of the plastic preforms.

In a further embodiment, the transport device transports the plastic preforms individually.

In a further embodiment, the heating elements are arranged laterally next to the transport path of the plastic preforms. In this way, the plastic preforms are guided past the heating elements and heated by them. In a further embodiment, at least one rotating device is provided which rotates the plastic preforms during their heating and, in particular, rotates them with respect to their longitudinal directions. In this way, uniform heating of the plastic preforms in their circumferential direction can be achieved. It is possible for this rotating device to rotate all the plastic preforms uniformly, for example by gearwheels moving with respect to a toothed rack.

In a further embodiment, the focusing device also extends along the transport path of the plastic preforms.

In a further embodiment, this transport path of the plastic preforms has areas with different curvatures. Particularly areas are provided along which the plastic preforms are guided in a substantially straight line, as well as areas in which they are guided along a curvature, for example in the surrounding areas of the heating device. In an embodiment, the heating devices are arranged, in particular, in the rectilinearly extending region of the apparatus.

As mentioned above, shielding devices are provided which keep the heating radiation away from certain areas of the plastic preforms. For example, shielding plates can be provided which shield the heating radiation from the mouth areas of the plastic preforms. In an embodiment, these shielding devices are arranged on a carrier, wherein the focusing device is also arranged on this carrier. However, the shielding devices could also be arranged on other areas of the apparatus.

In an embodiment, it would thus be possible for the shielding devices to also be adjustable and, in particular, to be adjustable to different types of plastic preforms.

Furthermore, it would also be possible that shielding devices are provided which are moved along with the plastic preforms.

In a further advantageous embodiment, the apparatus also comprises radiation reflector means or a radiation reflector suitable for reflecting the radiation emitted by the heating elements onto the plastic preforms. For example, tile elements may be provided which in turn reflect the radiation emitted by the heating elements onto the plastic preforms. For example, it is possible that such reflector devices are provided with respect to the transport path of the plastic preforms, opposite the heating elements and the focusing devices.

In an embodiment, the apparatus has a transport alley through which the plastic preforms are transported during their heating.

In a further embodiment, a plurality of the heating elements and/or heating devices described herein are arranged along the transport path of the plastic preforms.

In a further embodiment, the apparatus comprises a plurality of holding devices suitable and intended for holding the plastic preforms. In particular, but not exclusively, these may be holding mandrels suitable to be inserted into the mouths of the plastic preforms to hold them.

An automated adjustment of the focussing device to the plastic preforms is therefore proposed.

Different procedures are conceivable for this, as explained in more detail below. For example, an adjustment can be carried out automatically by a machine, for example automated by the input of variety parameters.

In addition, it is conceivable that such an adjustment takes place centrally, i.e., that several focusing devices can be adjusted. This can be done, for example, via a central input device. The input device can be a control panel, for example.

In addition, it is also possible to store certain adjustments and/or positions so that when changing over to plastic preforms, it is possible to fall back on settings that have already been stored. In this way, an adjustment can also be traced, for example via a counter, and can also be queried with repeat accuracy, if necessary, electrically, and reported back to a machine control.

In addition, it is also possible that an adjustment device, in particular but not exclusively a mechanical adjustment device, is used to find the ideal position of the focal point of the focusing device on the respective plastic preform.

Further, it is also possible that a removable and/or fixed mechanical device is provided for adjusting the focusing device.

In addition, as listed in more detail below, a sensing device with a sensing tip or also with an optical marking of the focal point of a reflector can also be provided as an adjustment device.

It is possible to place this probe or optical marker on a desired focal point on the plastic preform.

Such a probe or an optical marker can also be used to teach in a variety parameter, for example with regard to a focal point for a specific plastic preform.

In an embodiment, the focusing device is adjustable together with the heating element. It is possible that the heating element is mechanically coupled to the focussing device, for example that it is arranged within this focussing device. The focusing device may, for example, be in the form of a reflector gutter with a focusing or highly beam-bundling property. For example, the focussing device may have an at least partially elliptical profile, wherein the tubular heating device is placed in the first focal point of the elliptical contour, so that a focal point with strongly focused radiation is created in the second focal point, which is directed towards the preform.

Alternatively, the focusing device can have an at least partially parabolic profile. In this case, the tubular heating device is placed in the reflector gutter in such a way that an area of highly bundled radiation is generated, which is directed towards the preform.

In a further embodiment, the focusing device is arranged on a movable carrier. Particularly, the focusing device is arranged together with the heating element on this carrier. In addition, a shielding device can also be provided on this carrier element to shield the heating radiation from the mouths of the containers.

In a further embodiment, the apparatus has a motorised drive device for moving the focusing device. In particular, an electric motor drive device can be provided. For example, an electric motor or a linear motor can be provided to effect this movement. In addition, a drive mechanism, such as a spindle mechanism, can also be provided to move the focusing device.

An electric motor in the form of a linear motor can also be provided.

In addition, however, it is also possible that the drives are hydraulic and/or pneumatic drives.

In a further advantageous embodiment, the apparatus has a control device that enables the focusing device to be moved as a function of the preforms to be heated. It is conceivable that this control device detects which type of preforms are to be heated and the control device adjusts the position of the focusing device depending on this type of preforms.

In a further embodiment, the motorised drive device has at least two motorised drive elements which are suitable, for example, for moving the focussing device in two different directions, for example perpendicular to each other. In this way, the apparatus can be automatically adapted to different plastic preforms to be heated. As mentioned above, the provision of a user input is possible, i.e., the user can enter a desired setting, for example via an operating device such as a touch panel.

In addition, however, fully automatic adjustment is also possible, i.e., it can be recognised, for example, which types of plastic preforms are to be heated and the position of the focusing device can be adjusted accordingly.

In a further embodiment, the drive device allows movement of the focusing device in at least one direction and/or a pivoting movement.

For example, a translatory movement is possible, for example a translatory movement in the longitudinal direction of the plastic preforms. In addition, a movement perpendicular to a longitudinal direction of the plastic preforms is also possible, by which a distance between the focusing device and the plastic preforms to be heated is changed. In addition, rotational movements, for example swivel movements, are also possible.

Finally, parallel kinematics can also be used as a drive device, as described in more detail below.

In a further embodiment, the focusing device is pivotable by the drive device with respect to a predetermined axis and, in particular, also pivotable with respect to an axis that extends parallel to or along the transport path.

In a further embodiment, the transport device is a circulating transport device, which in particular has a circulating transport chain or a circulating transport belt.

In a further embodiment, the focusing device is a reflector device and in particular a parabolic reflector device or elliptical reflector device. This focusing device can be arranged particularly laterally next to the transport path of the plastic preforms. In particular, the focusing device cannot be moved along the direction of movement of the plastic preforms. Particularly, the focusing device is immovable during operation of the device.

It is possible that a certain position of the focusing device is fixed and/or locked.

Embodiments of the present invention are further directed to a method for heating plastic preforms, wherein a transport device transports the plastic preforms along a predetermined transport path and at least one stationary arranged heating device heats the plastic preforms transported along the transport path, wherein the heating device comprises at least one heating element which emits radiation heating the plastic preforms, and at least one focusing device which directs and/or focuses the radiation emitted by the heating element onto predetermined regions of the plastic preforms to be heated.

According to embodiments of the invention, a position of this focusing device is changed. In particular, a position of this focusing device is also changed taking into account a plastic preform to be heated and in particular taking into account its geometry.

In an embodiment, the focusing device directs the heating radiation onto a region of the plastic preform arranged below a support ring, in particular a region of the plastic preform arranged directly below a support ring of the plastic preform.

Embodiments of the present invention enable quick adjustment and can also ensure low machine downtimes. Furthermore, a reproducible and accurate adjustment is made possible. In addition, a consistently high quality of the customer's project can be achieved. In addition, a simple setting, for example on a control panel of a machine or automated by software, is also conceivable. The ergonomics of the system can also be improved.

### BRIEF DESCRIPTION

Some of the embodiments will be described in detail, with reference to the following figures, wherein like designations denote like members, wherein:

FIG. 1 shows a plant according to embodiments of the invention for producing containers with an apparatus according to embodiments of the invention;

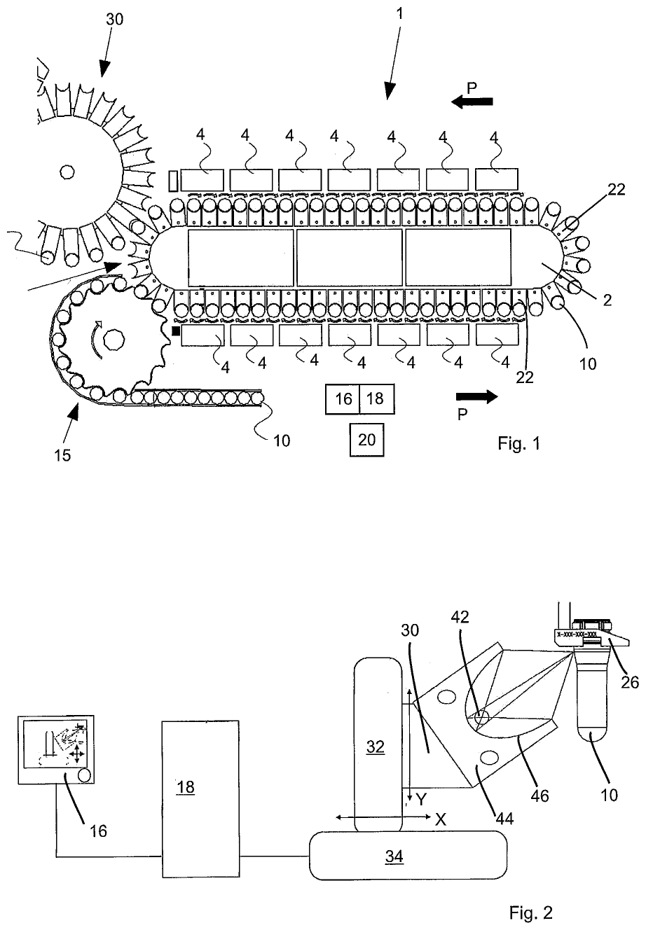

FIG. 2 shows a schematic representation of an apparatus according to embodiments of the invention;

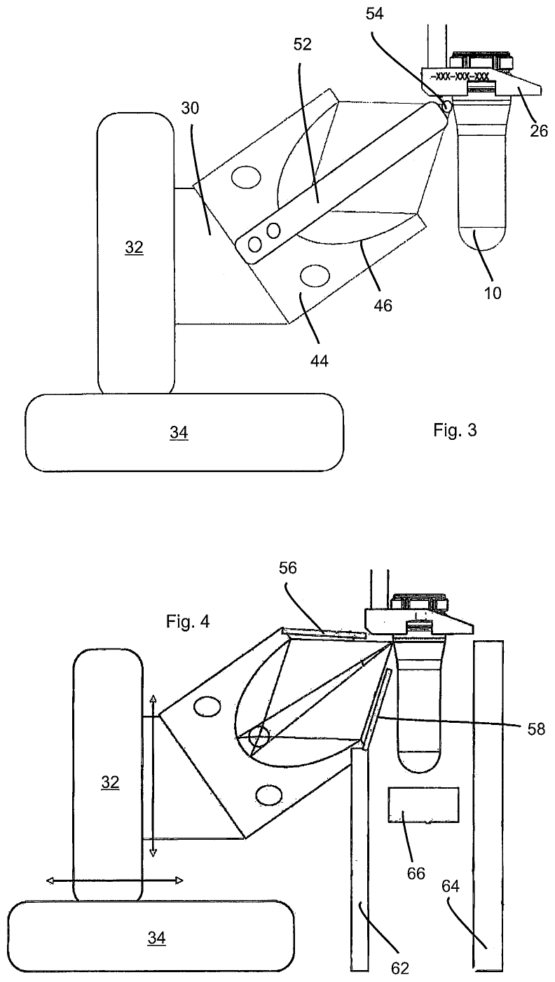

FIG. 3 shows a diagram illustrating the adjustment of a focusing device;

FIG. 4 a further illustration of an apparatus according to embodiments of the invention;

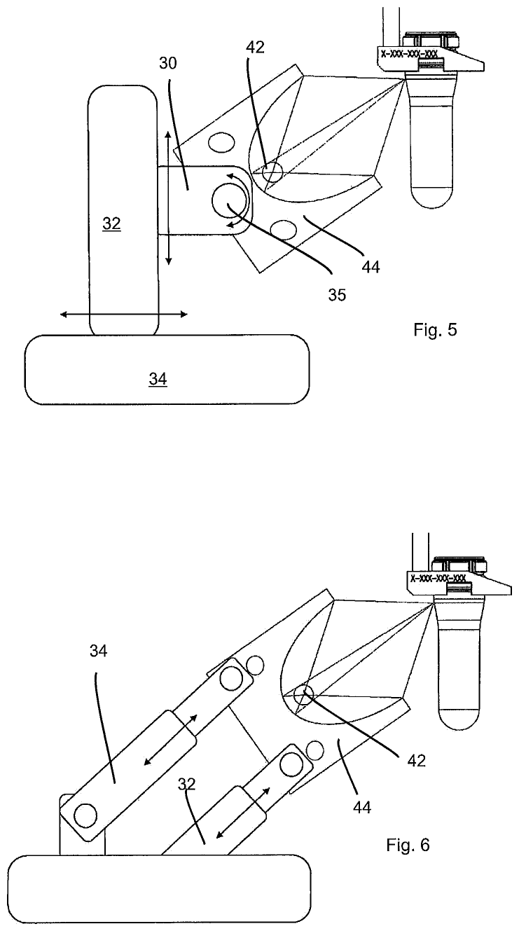

FIG. 5 shows an illustration of a further movement mechanism for an apparatus according to embodiments of the invention; and

FIG. 6 shows a further illustration of a movement mechanism for an apparatus according to embodiments of the invention.

### DETAILED DESCRIPTION

FIG. 1 shows a plant for manufacturing plastic containers. Plastic preforms 10 are separated by a separating device such as a single-cycle starwheel 15 and then transferred to an apparatus 1 for heating. This apparatus 1 for heating has a transport device 2 on which a plurality of holding elements 22 are arranged for holding the plastic preforms. The reference signs 4 indicate heating devices, which are arranged stationary here and which emit infrared radiation to the plastic preforms transported past the heating devices.

The plastic preforms are transported along a transport path P past a plurality of stationary heating devices 4.

After being heated, the plastic preforms are transferred to a transfer device 30, such as a distribution delay starwheel, from which they are in turn transferred to a forming device (not shown) for forming the plastic preforms into the plastic containers.

In addition, as shown in FIG. 1, the apparatus can also have a detection device 20 (shown schematically) for detecting plastic preforms. The data recorded by this detection device can be used to control the focussing device 44 (FIG. 2) or to track its movement.

The reference sign 16 indicates an input device by which the user can enter inputs to the apparatus. For example, the user could indicate via the input device which plastic preforms are to be heated and the control device 18 can then make an adjustment to the focusing device.

FIG. 2 shows a more detailed illustration of the apparatus according to embodiments of the invention. A plastic preform 10 is shown here, as well as a shielding device 26, which is intended to keep heat radiation away from a threaded region of this plastic preform. The reference sign 42 identifies a heating element, in particular a radiant heater, which is arranged within an elliptical reflector 46. The reference sign 44 accordingly identifies the focussing device and the reference sign 30 the carrier on which the focussing device but also the heating element 42 is arranged.

This carrier 30 is here adjustable or movable by two drive motors 32 and 34 in the X and Y directions shown in the figure, in order to position the focus of the radiant heaters on the plastic preform.

The reference sign 18 indicates a control device in the form of a machine control which is used to control the drive devices 32 and 34. For example, the drive device or the carrier 30 can be adjusted by a user command.

The reference sign 16 indicates the input device, such as an operating panel, through which the user can enter a positioning of the focusing device in addition to or as an alternative to the type of preform. This input device also particularly has a display on which the user of the focusing device and its movement are indicated.

FIG. 3 shows an illustration for carrying out an adjustment of the focusing device. Here, an adjustment device 52 is provided that can be detached or also permanently mounted. This has a sensing tip 54 which corresponds to a focus of the focusing device, for example the focal point of an elliptical reflector. This sensing tip can be guided to the plastic preform 10 in order to position it precisely.

FIG. 4 shows a further illustration of an apparatus according to embodiments of the invention. In addition to the focusing device, shielding screens 56 and 58 are also provided here to prevent radiation from reaching other areas of the plastic preform, such as its mouth area.

The reference signs 62 and 64 each indicate a tile and a counter-tile, which in turn serves to reflect radiation onto the plastic preform. Reference sign 66 indicates a bottom tile that is used to radiate or reflect heat onto the bottom area of the plastic preform.

FIG. 5 shows a further illustration showing a movement of the focusing device. In addition to the two drive devices 32 and 34, a rotary drive device 35 is also shown here, which enables the focusing device to be pivoted in order to facilitate its positioning.

In the illustration shown in FIG. 6, a parallel kinematic consisting of two drives 32 and 34 is provided, which also enables the focusing device 44 to be positioned with the heating element 42.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCE SIGNS

1 apparatus

2 transport device

4 heating device

10 plastic preform

15 single-cycle star

16 input device

18 control device

20 detection device

22 holding device

26 shielding device

30 carrier

32, 34 drive device

35 drive device

42 heating element

44 focusing device

46 elliptical reflector

52 adjustment device

54 sensing tip

56, 58 shielding screens

62, 64 tile

66 bottom tile

P transport path

1. An apparatus for heating plastic preforms with a transport device which is suitable and intended for transporting the plastic preforms along a predetermined transport path, with at least one stationary arranged heating device which heats the plastic preforms transported along the transport path, wherein the heating device has at least one heating element) which emits radiation which heats the plastic preforms, and at least one focusing device which focuses the radiation emitted by the heating element onto predetermined regions of the plastic preforms to be heated, wherein a position of this focusing device is changeable.

2. The apparatus according to claim 1, wherein the focusing device is adjustable together with the heating element.

3. The apparatus according to claim 1, wherein the focusing device is arranged on a movable carrier.

4. The apparatus according to claim 1, wherein the apparatus has a motorised drive device, for moving the focusing device.

5. The apparatus according to claim 1, wherein the apparatus has a control device which enables the focusing device to be moved as a function of the preforms to be heated.

6. The apparatus according to claim 4, wherein drive device enables a movement of the focusing device in at least one direction and/or a pivoting movement.

7. The apparatus according to claim 1, wherein the transport device has a circulating transport chain or a circulating transport belt.

8. The apparatus according to claim 1, wherein the focusing device comprises a reflector device and in particular a parabolic reflector device or elliptical reflector device.

9. A method for heating plastic preforms, wherein a transport device transports the plastic preforms along a predetermined transport path, and at least one stationary arranged heating device heats the plastic preforms) transported along the transport path, wherein the heating device has at least one heating element which emits radiation which heats the plastic preforms, and at least one focusing device which focuses the radiation emitted by the heating element onto predetermined regions of the plastic preforms to be heated, wherein a position of this focusing device is changed.

10. The method according to claim 9, wherein the position of the heating device is changed taking into account a plastic preform to be heated.
